(19) United States
(12) Patent Application Publication
(10) Pub. No.: US 2017/0288866 A1
(43) Pub. Date: Oct. 5, 2017

(54) SYSTEMS AND METHODS OF CREATING A DISTRIBUTED RING OF TRUST

(71) Applicant: Avast Software s.r.o., Praha 4 (CZ)

(72) Inventors: Petr Vanëk, Velke Nemcice (CZ); Jan Schwarz, Letovice (CZ); Pavel Studený, Praha 5 (CZ)

(21) Appl. No.: 15/470,693

(22) Filed: Mar. 27, 2017

Related U.S. Application Data
(60) Provisional application No. 62/315,149, filed on Mar. 30, 2016.

(51) Int. Cl. H04L 9/08; H04L 29/06; H04L 9/32

(52) U.S. Cl. CPC H04L 9/0827; H04L 9/3255; H04L 9/3234; H04L 9/3268; H04L 63/061; H04L 63/0823; H04L 9/0816; H04L 9/3247

(57) ABSTRACT

A trust relationship can be established between two or more identities without the need of a certificate authority. Trust relationships between identities can be maintained in a distributed ring of trust between two or more identities. The distributed ring of trust can be on a signed identity list. A node desiring to add an identity to the ring of trust sends a request to a member of the ring of trust. The receiving member can determine whether or not to approve the request. In some aspects, approval can be based on a previously shared key or a two-party verification. Upon approval, the requested identity is added to a trusted identity list indicating identities associated with current members of the ring of trust. The updated trusted identity list can then be distributed to the members of the ring of trust.

### CROSS-REFERENCE TO RELATED APPLICATIONS

This application claims priority to U.S. provisional application No. 62/315,149, filed on Mar. 30, 2016 which is hereby incorporated by reference in its entirety.

### FIELD

The disclosure relates generally to computing systems, and more particularly, to systems and methods of establishing and using a distributed ring of trust between entities in computing systems.

### BACKGROUND

In a computer security, an identity is a set of credentials used to gain access to computer systems, digitally sign a document or encrypt data. A most primitive identity might be formed by a user name and password. However, to allow a public verification, an identity has to be composed from a public and private key pair, that is used in asymmetric cryptographic algorithms, such as RSA or Elliptic Curves (EC). The identity is managed by software running on a computer or other electronic device.

Trust between identities is traditionally implemented by each identity having a certificate, that is validated against the issuing certificate authority. This in turn creates the need for the certificate authority and to establish a trust with this certificate authority.

When trust is implemented via a certificate authority, communicating parties present each other with their certificate. A certificate contains, among other things, the purpose of the certificate, an owner's public key and the public key hash. A certificate is digitally signed by a certificate authority. A certificate is often only issued to a trusted identity. A trust may be established for example by submitting login credentials.

### BRIEF DESCRIPTION OF THE DRAWINGS

For a better understanding of the disclosure, reference may be made to the accompanying drawings in which:

FIG. 1A is a block diagram illustrating an example of a system utilizing a distributed ring of trust.

FIG. 1B is a block diagram illustrating an example of a system in which the ring of trust is stored in a shared storage.

FIG. 2 is a sequence diagram illustrating an example embodiment of a method for adding an identity of a trusted node to a trusted identity list.

FIG. 3 is a sequence diagram illustrating an example embodiment of a method for granting a new node privilege to add identities to the trusted identity list.

FIG. 4 is a flow chart illustrating an example embodiment of a method for verifying that a node is a trusted node.

FIG. 5 is a block diagram of an example embodiment of a computer system upon which embodiments of the inventive subject matter can execute.

### DETAILED DESCRIPTION

In the following detailed description of example embodiments of the invention, reference is made to the accompanying drawings that form a part hereof, and in which is shown by way of illustration specific example embodiments in which the invention may be practiced. These embodiments are described in sufficient detail to enable those skilled in the art to practice the inventive subject matter, and it is to be understood that other embodiments may be utilized and that logical, mechanical, electrical and other changes may be made without departing from the scope of the inventive subject matter.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component that appears in multiple Figures. Signals and connections may be referred to by the same reference number or label, and the actual meaning will be clear from its use in the context of the description. In general, the first digit(s) of the reference number for a given item or part of the invention should correspond to the Figure number in which the item or part is first identified.

The description of the various embodiments is to be construed as examples only and does not describe every possible instance of the inventive subject matter. Numerous alternatives could be implemented, using combinations of current or future technologies, which would still fall within the scope of the claims. The following detailed description is, therefore, not to be taken in a limiting sense, and the scope of the inventive subject matter is defined only by the appended claims.

The disclosure provides details of various systems and methods that can establish a trust relationship between two or more identities without the need of a certificate authority. Trust relationships between identities can be maintained in a distributed ring of trust between two or more identities. The distributed ring of trust can be on a signed identity list. Thus, a central certificate authority or any other type of central service is not required. Instead, member nodes of the ring of trust can perform the authorization services. An identity list is used in place of certificates.

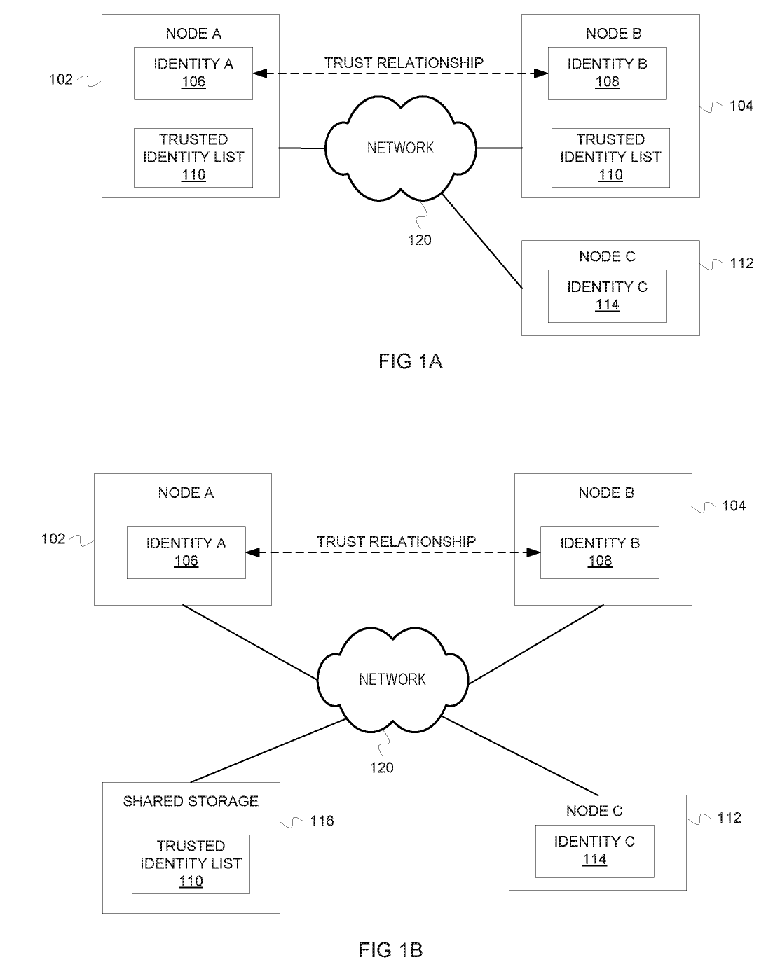

FIG. 1A is a block diagram illustrating an example of a system 100 utilizing a distributed ring of trust. In some aspects, system 100 includes a node A 102, a node B 104 and node C 112, where node A 102, node B 104 and node C 112 can be communicably coupled via a network 120. As used herein, a node can refer to a computing device such as a desktop computer, server computer, laptop computer, tablet computer, mainframe computer, smart phone, personal digital assistant, set top box, or any other computing device capable of executing the methods described herein. Further, a node can refer to an application executing on such a computing device.

In some aspects, network 120 can be a local area network, wide area network, intranet, or other type of network. In some aspects, network 120 can be the Internet.

Each of nodes A 102, B 104 and C 112 have an identity 106, 108 and 114 respectively. In some aspects, an identity can be represented by a public and private key pair. The key pair can be based, for example, on an Rivest-Shamir-Adleman (RSA) cryptosystem or an elliptical circle (EC) cryptosystem. A creation of the key pair can be equivalent to a creation of the identity.

In the example illustrated in FIG. 1A, nodes A 102 and B 104 trust one another as indicated by the trust relationship between their respective node identities 106 and 108. Node C 112 is not in a trust relationship with either node A 102 or node B 104. In some aspects, the trust relationship can be specified in a trusted entity list 110. Trusted identity list 110 can be a list holding a digest (hash) of a public key of all trusted ring members (e.g., nodes A 102 and B 104). The trusted identity list 110 can be digitally signed by a shared key. In the example illustrated in FIG. 1A, the trusted identity list 110 can be synchronized between the nodes having identities in the trusted identity list. A conflict resolution mechanism can be implemented to solve situations when, for example, two identities are added to two copies of the identity list and then these copies are synchronized. The conflict resolution mechanism can be any conflict resolution mechanism now known or developed in the future.

The shared key used to sign the trusted identity list 110 can be an asymmetric key pair that is shared among all trusted identities. The shared key can be created when the trusted identity list 110 is created. In some aspects, nodes holding the private key of the shared key pair can add new identities to the trusted identity list 110, thereby adding an identity to a distributed ring of trust. The public key of the shared key pair may be shared with non-trusted nodes to allow a verification of the trusted identity list 110.

FIG. 1B is a block diagram illustrating an example system 150 in which the identities of the ring of trust are stored in a shared storage. As in system 100 of FIG. 1A, system 150 includes node A 102, a node B 104 and node C 112. In addition, system 150 includes a shared storage 116. Shared storage 116 can be at a shared network location known to at least node A 102 and node B 104. In the example illustrated in FIG. 1B, the trusted identity list 110 is maintained in shared storage 116. In some aspects, a lock mechanism can be used to prevent simultaneous writes to the trusted identity list 110. Other mechanisms to prevent simultaneous writes now known or developed in the future could be used.

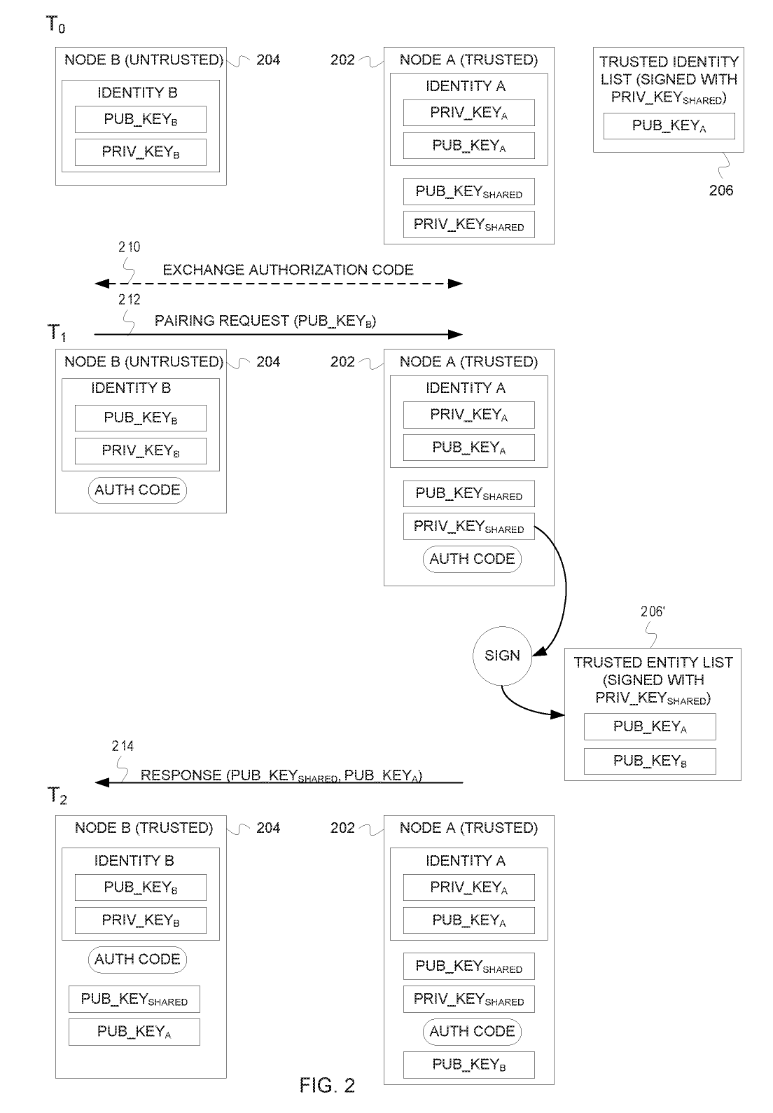

FIG. 2 is a sequence diagram illustrating a method for adding an identity of a trusted node to a trusted identity list. At time T₀, the trusted identity list 206 is created by node A 202 with the identity of node A 202.

At operation 210, node A 202 and node B 204 exchange an authorization code. The authorization code can be a previously shared secret (e.g. login credentials) or the result of a two-party verification where an authorization code is calculated from a public key (e.g., the public key of the identity of a node). The authorization code can be used later to approve addition of identities to the trusted identity list 206.

At operation 212, node B 204 issues an approval request to add a new identity (e.g., the identity of node B 204) to the trusted identity list 206. The approval request can be made by sending the approval request to one or more member nodes via a direct network connection, an e-mail, a push notification or any other means. In some aspects, a member node can be discovered via a UPnP protocol. In alternative aspects, the requesting node (i.e., node B 204) can send the request to a well known location. For example, the request can be sent to a server at a known location. The server can then forward the request to a known member of the ring of trust. The approval request can include the new identity public key.

The approval request can be approved by a member of the ring of trust (e.g., node A 202, a node whose identity is currently in the trusted identity list). Approval can include displaying an authorization code. For example, the authorization code can be a short hash displayed as a decimal number. Both sending and approving nodes can display the same authorization code, so that a user may cross-check that the intended identity is being approved. An approval request may be sent to multiple members of the ring of trust. In some aspects, a first recipient may approve the request and add the new member, while the other recipients see that the new member is already in the trusted identity list, and can ignore the request.

Upon approval, at time T1, the requested identity is added to the trusted identity list 206. The updated trusted identity list will be referred to as trusted identity list 206′. The trusted identity list 206′ is signed by node A 202 (i.e., the node approving addition of the new identity). In some aspects, the trusted identity list is signed using a shared private key.

At operation 214, a response is sent to the requesting node (e.g., node B 204) that the node's identity has been added to the trusted identity list 206′. The response can include the shared public key and the public key of the node approving addition of the identity (e.g., node A 204).

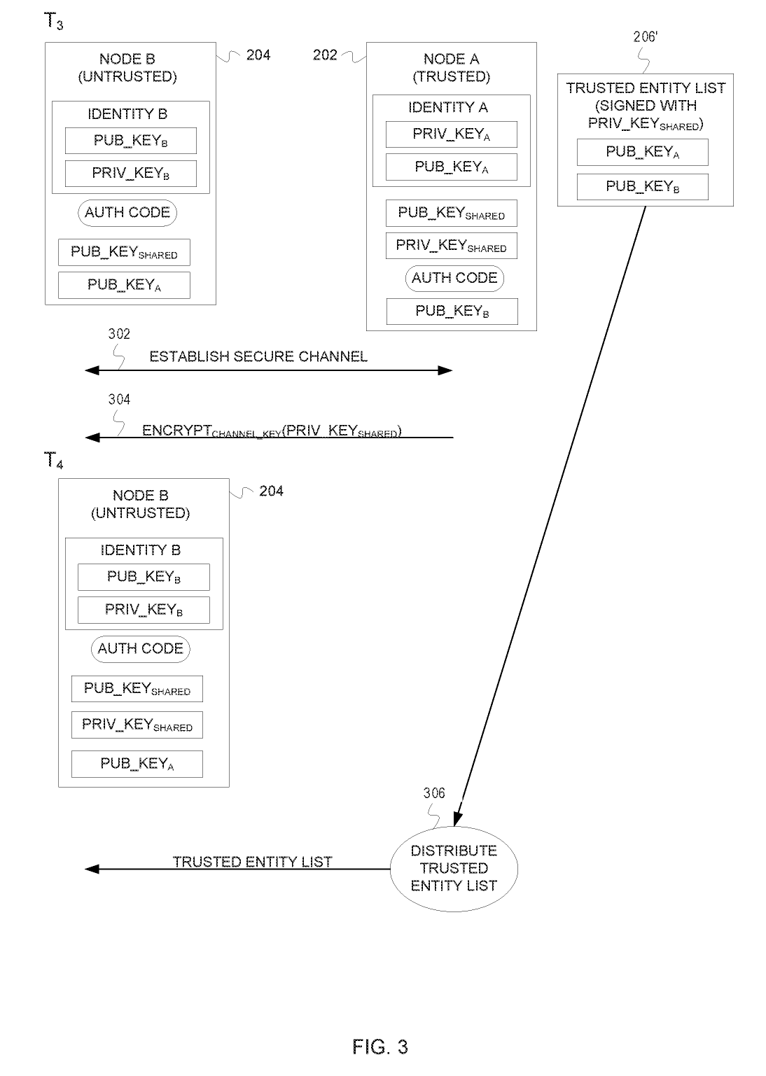

FIG. 3 is a sequence diagram illustrating an example of a method for granting a new node privilege to add identities to the trusted identity list. In some aspects, the new identity (e.g., node B 204) can also gain privileges to accept members into the ring of trust by adding identities to the trusted identity list 206. At operation 302, the parties (e.g., node A 202 and node B 204) establish a secure channel using a key-agreement protocol. Such a protocol can be based, for example, on a Diffie-Hellman algorithm, such as RSA key exchange or Elliptic curve Diffie-Hellman.

At operation 304, the approving identity (e.g., node A 202) sends a shared private key to the new identity over the secure channel. Once an identity has the shared private key, it can add other identities to the identity list and sign the list using the shared private key.

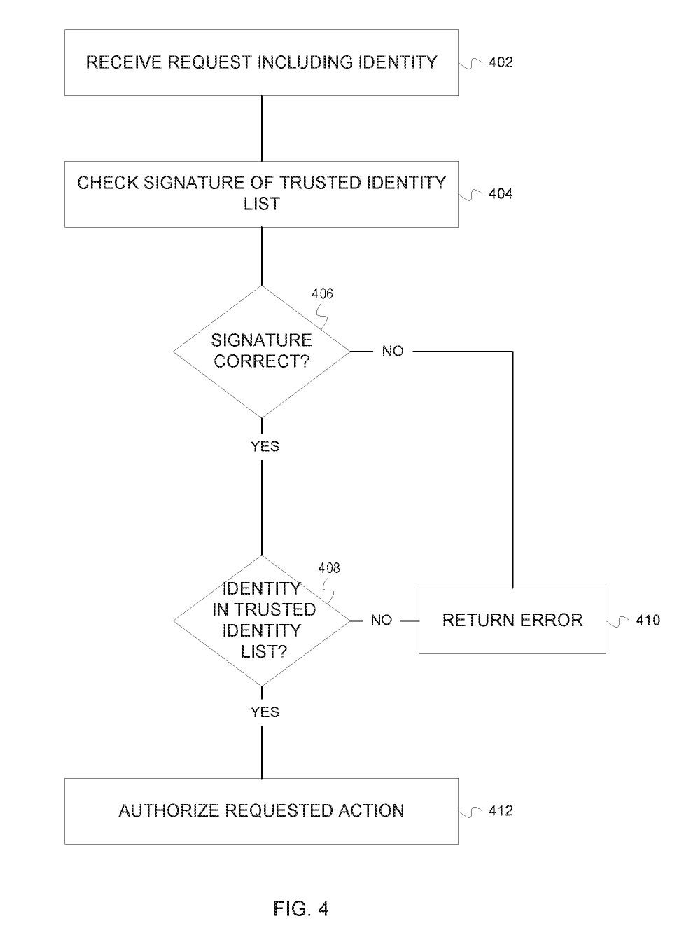

FIG. 4 is a flow chart illustrating a method for verifying that a node is a trusted node. At block 402, a request to authorize an action is received. The request can include the identity of the requesting node.

At block 404, the trusted identity list is verified. In some aspects, the trusted identity list is verified by checking its digital signature. In particular aspects, the digital signature can be checked using shared public key or shared private key. If the digital signature is invalid, i.e. the identity list hasn't been correctly signed, then the method proceeds to block 410, where an error is returned to the requestor. Further, in some aspects, other operations among the ring members cannot be performed and the ring of trust has to be re-established.

If the trusted identity list is successfully verified, then at block 408, a check is made to determine if the identity included in the request is in the trusted identity list. If not, then at block 410 an error is returned and the request is denied. Of the identity included in the request is in the trusted identity list, then at block 412, the requested action is authorized.

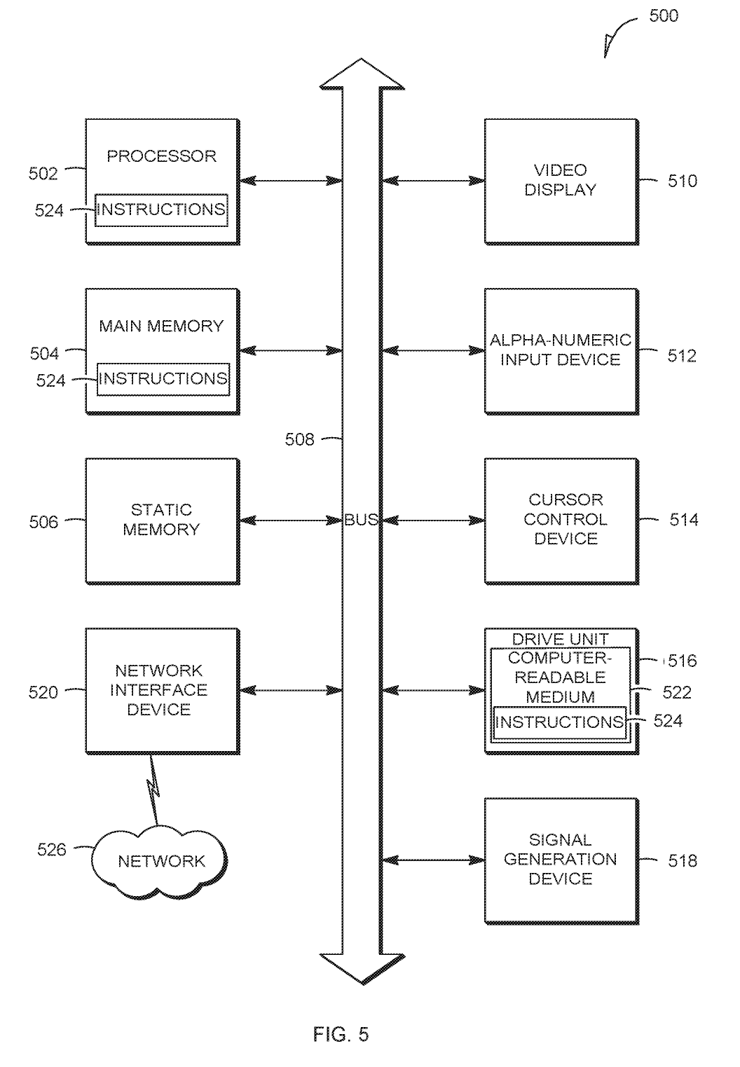

FIG. 5 is a block diagram of an example embodiment of a computer system 500 upon which embodiments of the inventive subject matter can execute. The description of FIG. 5 is intended to provide a brief, general description of suitable computer hardware and a suitable computing environment in conjunction with which the invention may be implemented. In some embodiments, the inventive subject matter is described in the general context of computer-executable instructions, such as program modules, being executed by a computer. Generally, program modules include routines, programs, objects, components, data structures, etc., that perform particular tasks or implement particular abstract data types.

Moreover, those skilled in the art will appreciate that the aspects of the disclosure may be practiced with other computer system configurations, including hand-held devices, multiprocessor systems, microprocessor-based or programmable consumer electronics, smart phones, network PCs, minicomputers, mainframe computers, and the like. Aspects of the disclosure may also be practiced in distributed computer environments where tasks are performed by I/O remote processing devices that are linked through a communications network. In a distributed computing environment, program modules may be located in both local and remote memory storage devices.

With reference to FIG. 5, an example embodiment extends to a machine in the example form of a computer system 500 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. Further, while only a single machine is illustrated, the term “machine” shall also be taken to include any collection of machines that individually or jointly execute a set (or multiple sets) of instructions to perform any one or more of the methodologies discussed herein.

The example computer system 500 may include a processor 502 (e.g., a central processing unit (CPU), a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). In example embodiments, the computer system 500 also includes one or more of an alpha-numeric input device 512 (e.g., a keyboard), a user interface (UI) navigation device or cursor control device 514 (e.g., a mouse), a disk drive unit 516, a signal generation device 518 (e.g., a speaker), and a network interface device 520.

The disk drive unit 516 includes a machine-readable medium 522 on which is stored one or more sets of instructions 524 and data structures (e.g., software instructions) embodying or used by any one or more of the methodologies or functions described herein. The instructions 524 may also reside, completely or at least partially, within the main memory 504 or within the processor 502 during execution thereof by the computer system 500, the main memory 504 and the processor 502 also constituting machine-readable media.

While the machine-readable medium 522 is shown in an example embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable storage medium” shall accordingly be taken to include, but not be limited to, solid-state memories and optical and magnetic media that can store information in a non-transitory manner, i.e., media that is able to store information. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 524 may further be transmitted or received over a communications network 526 using a signal transmission medium via the network interface device 520 and utilizing any one of a number of well-known transfer protocols (e.g., FTP, HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “machine-readable signal medium” shall be taken to include any transitory intangible medium that is capable of storing, encoding, or carrying instructions for execution by the machine, and includes digital or analog communications signals or other intangible medium to facilitate communication of such software.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

As is evident from the foregoing description, certain aspects of the inventive subject matter are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the inventive subject matter. Therefore, it is manifestly intended that this inventive subject matter be limited only by the following claims and equivalents thereof.

The Abstract is provided to comply with 37 C.F.R. §1.72(b) to allow the reader to quickly ascertain the nature and gist of the technical disclosure. The Abstract is submitted with the understanding that it will not be used to limit the scope of the claims.

What is claimed is:

1. A computerized distributed ring of trust comprising:
a first computerized node of a plurality of computerized nodes each having an identity and communicatively coupled via an electronic communications network, the first node creating a trusted identity list and configured to receive requests via the communications network;
a second computerized node of the plurality of computerized nodes, which sends a request to add the identity of the second node to the trusted identity list via the communication network;
the first node receiving the request and determining whether to approve the request based at least in part on an authorization code and in response to approving the request, the first node adding the identity of the second node to the trusted identity list, signing the trusted identity list with a shared private key, and providing a response indicating approval of the request to the second node via the communication network.

2. The ring of trust of claim 1 further comprising a shared memory coupled to the communication network which stores the identities of the plurality of nodes and is shared by the plurality of nodes.

3. The ring of trust of claim 1 wherein providing the response indicating approval of the request comprises providing the trusted identity list to one or more members of the ring of trust.

4. The ring of trust of claim 1 wherein the identity of the second node comprises a key pair associated with the second node.

5. The ring of trust of claim 4 wherein the trusted identity list comprises a list of key pairs associated with the members of the ring of trust, and wherein adding the identity to the trusted identity list comprises adding the key pair associated with the second node to the list of key pairs.

6. The ring of trust of claim 1 wherein the authorization code comprises a previously shared secret.

7. The ring of trust of claim 1 wherein the authorization code comprises a result of a two-party verification between the first node and the second node.

8. The ring of trust of claim 1 further comprising the first node sending the shared private key to the second node via a secure channel to enable the second node to approve additions to the trusted identity list.

9. A method for maintaining a ring of trust, the method comprising:
receiving via an electronic communications network, by a first computerized node in the ring of trust from a second computerized node not in the ring of trust, a request to add an identity associated with the second node to a trusted identity list via a communication network;
determining, by the first node and based at least in part, on an authorization code, whether to approve the request; and
in response to approving the request,
adding the identity to the trusted identity list, signing the trust identity list with a shared private key, and providing a response indicating approval of the request to the second node.

10. The method of claim 9, wherein providing the response indicating approval of the request comprises providing the trusted identity list to one or more members of the ring of trust.

11. The method of claim 9, wherein the identity of the second node comprises a key pair associated with the second node.

12. The method of claim 11, wherein the trusted identity list comprises a list of key pairs associated with members of the ring of trust, and wherein adding the identity to the trusted identity list comprises adding the key pair associated with the second node to the list of key pairs.

13. The method of claim 9, wherein the authorization code comprises a previously shared secret.

14. The method of claim 9, wherein the authorization code comprises a result of a two-party verification between the first node and the second node.

15. The method of claim 9, further comprising the first node sending the shared private key to the second node via a secure channel between the first node and the second node, wherein possession of the share private key enables the second node to approve additions to the trusted identity list.
